(19) United States
(12) Patent Application Publication
(10) Pub. No.: US 2007/0114771 A1
(43) Pub. Date: May 24, 2007

(54) Passenger protecting system for vehicle

(75) Inventors: Shingo Wanami, Kariya-city (JP); Toshihito Nonaka, Chiryu-city (JP); Satoru Takehara, Obu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/600,543

(22) Filed: Nov. 16, 2006

(30) Foreign Application Priority Data
Nov. 21, 2005 (JP) 2005-336099

(51) Int. Cl. B60K 28/10; B60R 21/0136

(52) U.S. Cl. 280/735; 180/274

(57) ABSTRACT

A passenger protecting system for a vehicle has a space defining member which partially constructs a chassis of the vehicle and defines therein an inner space deformable due to a collision of the vehicle, a pressure detection member which is arranged in the inner space to detect a pressure of air in the inner space, a temperature detection member which is arranged in the inner space to detect a temperature of air in the inner space, a determination unit, and a passenger protection device for protecting a passenger in the vehicle. The passenger protection device is actuated, when the determination unit determines that there occurs the collision of the vehicle based on a variation of the pressure and a variation of the temperature.

### CROSS REFERENCE TO RELATED APPLICATION

This application is based on a Japanese Patent Application No. 2005-336099 filed on Nov. 21, 2005, the disclosure of which is incorporated herein by reference.

### FIELD OF THE INVENTION

The present invention relates to a passenger protecting system, which can be suitably used for a vehicle.

### BACKGROUND OF THE INVENTION

Generally, as disclosed in JP-2-249740A, a vehicle can be provided with a pressure sensor for a detection of a collision of the vehicle. Specifically, an air tank which is closed is arranged in a door of the vehicle. The pressure in the air tank is detected by the pressure sensor. In the case where the pressure detected by the pressure sensor is larger than or equal to a predetermined threshold value, it is determined there occurs the collision between the vehicle and an obstacle. Thus, a passenger protection device of the vehicle such as an airbag and the like is actuated.

Moreover, as disclosed in JP-2654428B2 (U.S. Pat. No. 5,748,075), a pressure of a predetermined space in the vehicle and an acceleration of the vehicle which will vary due to a collision of the vehicle are detected. Whether or not there occurs the collision of the vehicle is repeatedly determined, respectively based on the pressure and the acceleration. In this case, the passenger protection device is actuated when the collision of the vehicle has been determined.

Furthermore, as disclosed in JP-2004-513824A (U.S. Pat. No. 6,725,961), a temperature of a predetermined space defined in the vehicle and the acceleration of the vehicle are detected. The temperature and the acceleration will vary due to the collision of the vehicle. Whether or not there occurs the collision of the vehicle is repeatedly determined, respectively based on the temperature and the acceleration. In this case, the passenger protection device is actuated when the collision of the vehicle has been determined.

According to JP-2654428B2 and JP-2004-513824A, the collision determination accuracy is improved because the collision is repeatedly determined.

However, according to JP-2654428B2, there is a difference between the time period elapsed from the collision occurrence to the collision detection based on the pressure, and that based on the acceleration. For example, in the case of the collision at the vehicle door, the collision is determined based on the pressure of the inner space of the vehicle door and the acceleration of the vehicle chassis. Generally, the vehicle door has a stiffness which is not so high, to be readily deformed. That is, when there occurs the collision between the door and the obstacle, the door is firstly deformed and then the vehicle chassis moves.

Therefore, the acceleration of the vehicle will vary after the pressure increase of the inner space of the vehicle door. Thus, the collision is detected based on the pressure of the inner space, and thereafter the collision is detected based on the acceleration of the vehicle. In this case, the passenger protection device will not be actuated, until the detection (which is later) of the collision based on the acceleration.

Similarly, according to JP-2004-513824A, there is a difference between the time period elapsed from the collision occurrence to the collision detection based on the temperature, and that based on the acceleration. In this case, the passenger protection device will not be actuated, until the detection (which is later) of the collision based on the acceleration.

### SUMMARY OF THE INVENTION

In view of the above-described disadvantages, it is an object of the present invention to provide a passenger protecting system, in which a collision of a vehicle is detected at an earlier time with an improved accuracy for an actuation of a passenger protection device.

According to the present invention, a passenger protecting system for a vehicle has a space defining member which partially constructs a chassis of the vehicle and defines therein an inner space deformable due to a collision of the vehicle, a pressure detection member which is arranged in the inner space to detect a pressure of air in the inner space, a temperature detection member which is arranged in the inner space to detect a temperature of air in the inner space, a determination unit and a passenger protection device for protecting a passenger in the vehicle. The determination unit determines whether or not there occurs the collision of the vehicle, based on a variation of the pressure detected by the pressure detection member and a variation of the temperature detected by the temperature detection member. The passenger protection device is actuated when the determination unit determines that there occurs the collision of the vehicle.

In this case, the collision of the vehicle is repeatedly determined, respectively based on the variation of the pressure and the variation of the temperature in the inner space of the space defining member which is fixed to the vehicle. Because the multiple kinds of information is used for the determination of the vehicle collision, the collision can be detected with an improved accuracy. Thus, an unnecessary actuation of the passenger protection device can be restricted.

Moreover, the variations of the pressure and the temperature used for the collision determination are in substantial synchronism with each other. In this case, the pressure and the temperature of the inner space increase substantially simultaneously, corresponding to the collision of the vehicle. That is, the time period elapsed from the occurrence of the collision to the determination (detection) of the collision based on the pressure variation is substantially equal to, the time period elapsed from the occurrence of the collision to the determination (detection) of the collision based on the temperature variation. Therefore, the collision can be detected at an earlier time, even when the collision is determined according to the multiple kinds of information.

Preferably, the passenger protecting system has a correction unit which determines a corrected pressure by correcting the pressure corresponding to the temperature. The pressure and the temperature are respectively detected by the pressure detection member and the temperature detection member. The determination unit determines whether or not there occurs the collision of the vehicle based on a variation of the corrected pressure and the variation of the temperature.

In this case, the temperature in the inner space detected by the temperature detection member is used for the determination of the collision and for the correction of the pressure in the inner space. Therefore, it is unnecessary to provide an additional temperature detection member for detecting the ambient temperature of the pressure detection member. Thus, the pressure detected by the pressure detection member can be corrected with a reduced cost.

### BRIEF DESCRIPTION OF THE DRAWINGS

Other objects, features and advantages of the present invention will become more apparent from the following detailed description made with reference to the accompanying drawings, in which:

FIG. 1 is a schematic view showing a door of a vehicle according to a first embodiment of the present invention;

FIG. 2 is an enlarged partial sectional view showing a part II in FIG. 1 according to the first embodiment;

FIG. 3 is a block diagram showing a passenger protecting system according to the first embodiment;

FIG. 4 is a flow chart showing a determination process of a determination unit of an airbag ECU according to the first embodiment;

FIG. 5A is a graph showing a change of a corrected pressure variation with the time elapsing in the case of a collision of the door, and FIG. 5B is a graph showing a change of a temperature variation with the time elapsing in the case of the collision of the door; and

FIG. 6 is a block diagram showing a passenger protecting system according to a second embodiment of the present invention.

### DETAILED DESCRIPTION OF THE EXAMPLE EMBODIMENTS

### First Embodiment

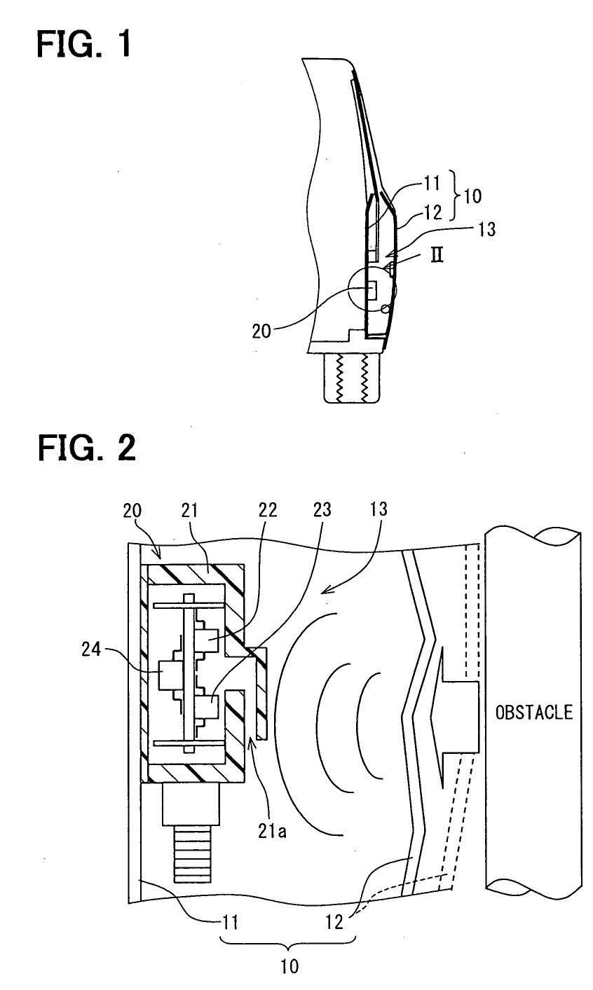

A passenger protecting system according to a first embodiment of the present invention will be described with reference to FIGS. 1-5. The passenger protecting system can be suitably used for a vehicle, for example. The passenger protecting system is provided with a sensor module 20, an airbag ECU 30, a passenger protection device 40 and the like.

As shown in FIG. 1, the sensor module 20 includes a housing 21, a pressure detection member 22 (e.g., pressure sensor), a temperature detection member 23 (e.g., temperature sensor) and a communication IC 24. The sensor module 20 is arranged in an inner space 13, which is defined in a space defining member (e.g., door 10). The space defining member can construct a part of the chassis of the vehicle, and be deformable due to a collision of the vehicle.

The door 10 has an inner panel 11 which is arranged at an inner side of a passenger compartment of the vehicle, and an outer panel 12 which is arranged at an outer side of the passenger compartment. The inner space 13 is defined between the inner panel 11 and the outer panel 12.

In this case, a surface (e.g., right side in FIG. 1) of the inner panel 11 and a surface (e.g., left side in FIG. 1) of the outer panel 12 are covered by a heat insulation material. These surfaces of the inner panel 11 and the outer panel 12 are positioned at the inner side of the inner space 13. That is, the most surfaces for defining the inner space 13 are covered by the heat insulation material.

The housing 21 which is hollow is arranged in the inner space 13 and attached to the inner panel 11. The housing 21 has an opening 21a through which the space in the housing 21 is communicated with the inner space 13 of the door 10. The opening 21a can be arranged at an opposite side of the housing 21 to the inner panel 11 (passenger compartment). The pressure and the temperature of air in the inner space 13 will vary due to the collision at the door 10 of the vehicle, and be transferred from the exterior of the housing 21 to the interior thereof through the opening 21a.

The pressure sensor 22 is fixed in the housing 21 to detect a variation of the pressure of air in the inner space 13 of the door 10. Specifically, the pressure sensor 22 can have a sensor chip 22a (i.e., pressure detection portion) and an amplification circuit 22b (i.e., pressure correction unit).

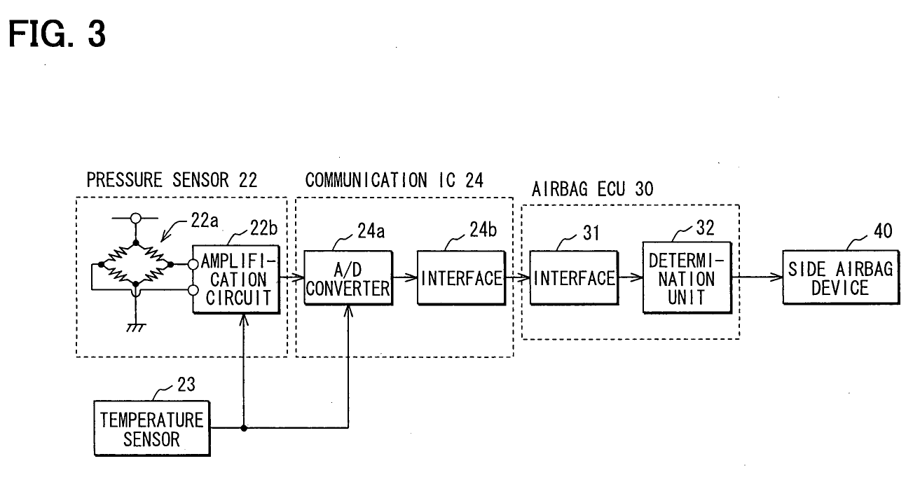

The sensor chip 22a includes a diaphragm which can be constructed of a silicon chip having a thin-walled center portion. A diffusion resistance which constructs a Wheatstone bridge is provided at the diaphragm. In the case where a pressure is applied to the sensor chip 22a so that the diaphragm is deformed, a potential difference between two ends (i.e., right end and left end in FIG. 3) of the sensor chip 22a varies. Thus, the sensor chip 22a outputs a signal of the potential difference between the two ends thereof. Therefore, the variation ΔP (caused by collision at door 10, for example) of the pressure applied to the sensor chip 22a can be detected via the potential difference signal.

In this case, the signal of the pressure variation ΔP outputted by the sensor chip 22a is related to the ambient temperature T of the sensor chip 22a (i.e., temperature T in housing 21). That is, the pressure variation ΔP detected by the sensor chip 22a has a variability due to the ambient temperature T.

The amplification circuit 22b is provided, to perform an amplification correction process of the pressure variation ΔP detected by the sensor chip 22a so that a corrected pressure variation ΔP1 is obtained. In this case, the amplification correction process includes an amplification process for proportionally amplifying the pressure variation ΔP outputted by the sensor chip 22a, and a correction process based on the temperature T detected by the temperature sensor 23. In the correction process, the pressure variation ΔP having been amplified can be corrected so that the variability thereof due to the ambient temperature T of the sensor chip 22a is eliminated. For example, correction amounts (to be used in correction process) corresponding to temperatures can be predetermined. Then, the correction amount corresponding to the temperature T which is practically detected by the temperature sensor 23 is, for example, added to the pressure variation ΔP detected by the sensor chip 22a. In this case, the correction of the pressure variation ΔP can be also performed before the amplification thereof.

According to this embodiment, the temperature sensor 23 is fixed in the housing 21 and positioned near the pressure sensor 22, to detect the temperature T and the temperature variation ΔT (caused by collision at door 10, for example) of air in the inner space 13 of the door 10.

The communication IC 24, which can be arranged in the housing 21, includes an A/D converter 24a and an interface 24b. The corrected pressure variation ΔP1 outputted from the pressure sensor 22 and the temperature variation ΔT outputted from the temperature sensor 23 are inputted to the A/D converter 24a to be A/D converted. Then, the corrected pressure variation ΔP1 and the temperature variation ΔT which have been A/D-converted are outputted to the airbag ECU 30 through the interface 24b.

The airbag ECU 30 can have an interface 31 and a determination unit 32. The information outputted from the interface 24b of the communication IC 24 is inputted to the determination unit 32 through the interface 31. Then, a determination process for determining whether or not actuate the passenger protection device 40 is performed by the determination unit 32, based on the information inputted thereto through the interface 31. A pressure threshold Pth and a temperature threshold value Tth which are used in the determination process can be beforehand memorized in the determination unit 32.

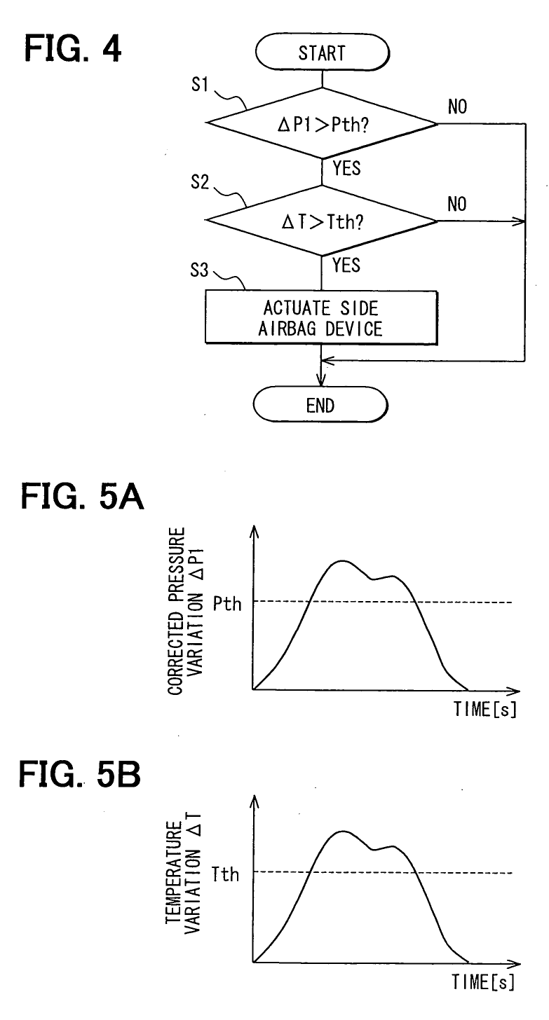

The determination process of the determination unit 32 of the airbag ECU 30 will be described with reference to FIG. 4. At first, at step S1, it is determined whether or not the corrected pressure variation ΔP1 is larger than the pressure threshold value Pth. In the case where the corrected pressure variation ΔP1 is smaller than or equal to the pressure threshold value Pth (i.e., S1: No), the process shown in FIG. 4 will be repeated from step S1.

On the other hand, in the case where the corrected pressure variation ΔP1 is larger than the pressure threshold value Pth (i.e., S1: Yes), it is further determined at step S2 whether or not the temperature variation ΔT is larger than the temperature threshold Tth.

In the case where the temperature variation ΔT is smaller than or equal to the temperature threshold value Tth (i.e., S2: No), the process shown in FIG. 4 will be repeated from step S1. On the other hand, in the case where the temperature variation ΔT is larger than the temperature threshold value Tth (i.e., S2: Yes), it is determined that there occurs the collision with the door 10 of the vehicle. Then, at step S3, the passenger protection device 40 is actuated. Thereafter, the process shown in FIG. 4 is repeatedly performed from step S1 when a predetermined time period has elapsed, for example.

In this embodiment, the passenger protection device 40 can include airbags, for example. The airbag can be deployed between the door 10 and a passenger when the collision at the door 10 has been determined.

Next, the operation of the passenger protecting system according to this embodiment will be described with reference to FIGS. 5A and 5B. FIG. 5A shows the change of the corrected pressure variation ΔP1 with the time elapsing, in the case of the collision of the door 10. FIG. 5B shows the change of the temperature variation ΔT with the time elapsing, in the case of the collision of the door 10.

Generally, the outer panel 12 of the door 10 has a stiffness which is not so high. Therefore, in the case where there occurs a collision at the outer panel 12, the outer panel 12 will be deformed to the side of the inner panel 11. That is, immediately after the occurrence of the collision of the outer panel 12, the inner space 13 is deformed to become narrow. Thus, the pressure in the inner space 13 increases.

Moreover, the temperature in the inner space 13 increases due to an adiabatic change. That is, the pressure variation ΔP and the temperature variation ΔT in the inner space 13 are in substantial synchronism with each other. As described above, because the most surfaces which define the inner space 13 are covered by the heat insulation material, the heat in the inner space 13 is restricted from radiating to the exterior of the inner space 13. Thus, the temperature of air in the inner space 13 will efficiently and substantially increase corresponding to the increase of the pressure, and be used for the collision determination.

In this case, the sensor chip 22a of the pressure sensor 22 detects the pressure variation ΔP in the inner space 13, which is transferred to the sensor chip 22a through the opening 21a. The temperature sensor 23 detects the temperature T and the temperature variation ΔT in the inner space 13 which is transferred thereto through the opening 21a. Furthermore, the corrected pressure variation ΔP1 can be obtained via the amplification circuit 22b of the pressure sensor 22, based on the pressure variation ΔP and the temperature T (i.e., ambient temperature of pressure sensor 22). That is, the pressure variation ΔP detected by the sensor chip 22a (pressure detection portion) is corrected via the temperature information outputted from the temperature sensor 23 (temperature detection member).

According to this embodiment, the pressure sensor 22 and the temperature sensor 23 are arranged in the housing 21 and positioned in close proximity to each other. Therefore, the pressure variation ΔP detected by the sensor chip 22a of the pressure sensor 22 and the temperature variation ΔT detected by the temperature sensor 23 are in substantial synchronism with each other. Accordingly, as shown in FIGS. 5A and 5B, the corrected pressure variation ΔP1 and the temperature variation ΔT are in substantial synchronism with each other.

In the case where the corrected pressure variation ΔP1 is larger than the pressure threshold value Pth with reference to FIG. 5A and the temperature variation ΔT is larger than the temperature threshold value Tth with reference to FIG. 5B, the passenger protection device 40 will be actuated.

In this case, because the collision of the outer panel 12 of the door 10 is repeatedly determined according to the corrected pressure variation ΔP1 and the temperature variation ΔT of the inner space 13 of the door 10, the determination accuracy can be improved. Furthermore, the corrected pressure variation ΔP1 and the temperature variation ΔT in the inner space 13 are in substantial synchronism with each other, so that the collision can be determined at an earlier time. Moreover, in this case, the corrected pressure variation ΔP1 which has been amplified and corrected by the amplification circuit 22b is used for the determination of the collision. That is, the variability of the signal outputted from the sensor chip 22a due to the ambient temperature T thereof can be eliminated.

Moreover, because the pressure sensor 22 and the temperature sensor 23 are arranged in the same housing 21, the synchronization between the signals from the pressure sensor 22 and the temperature sensor 23 can be improved. Furthermore, the space can be reduced and the cost can be decreased.

### Second Embodiment

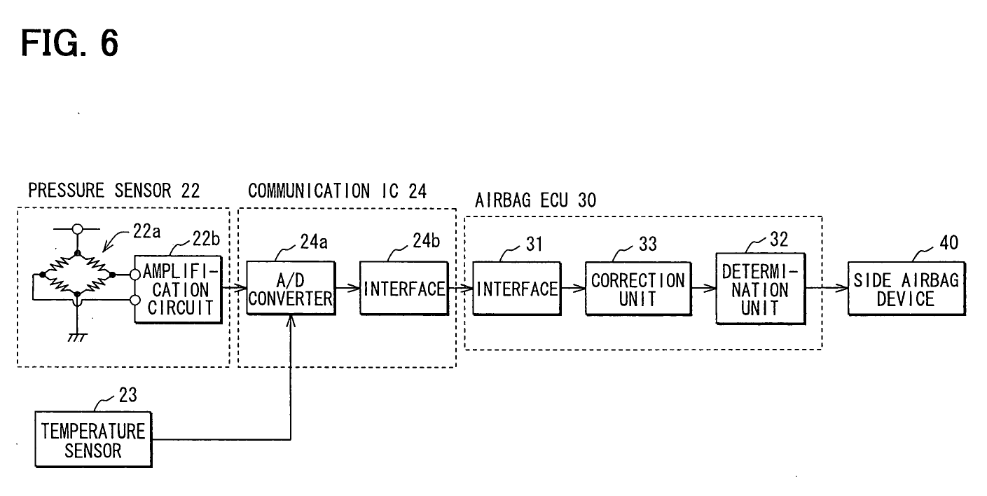

A second embodiment of the present invention will be described with reference to FIG. 6. In this case, the correction process of the pressure variation ΔP is performed by a correction unit 33 of the airbag ECU 30. That is, the airbag ECU 30 calculates the corrected pressure variation ΔP1 based on the pressure variation ΔP and the temperature T.

The passenger protecting system is provided with the sensor module 20, the airbag ECU 30 and the passenger protection device 40. The sensor module 20 which is arranged in the inner space 13 has the housing 21, the pressure sensor 22, the temperature sensor 23 and the communication IC 24. The pressure sensor 22 having the sensor chip 22a and the amplification circuit 22b is arranged in the housing 21, to detect the pressure variation ΔP of air in the inner space 13 of the door 10. The temperature T and the temperature variation ΔT of the inner space 13 are detected by the temperature sensor 23 which is arranged in the housing 12.

According to the second embodiment, the amplification circuit 22b performs the amplification process of the pressure variation ΔP detected by the sensor chip 22a. At the amplification process, the pressure variation ΔP outputted from the sensor chip 22a is proportionally amplified, for example.

The airbag ECU 30 has the interface 31, the determination portion 32, and the correction unit 33. The pressure variation ΔP having been amplified, the temperature T and the temperature variation ΔT (which are outputted from interface 24b of communication IC 24) are inputted to the correction unit 33 through the interface 31.

In this case, the pressure variation ΔP having been amplified is provided with the correction process by the correction unit 33, based on the temperature T. At the correction process, the pressure variation ΔP having been amplified is processed so that the variability thereof due to the ambient temperature T of the sensor chip 22a is eliminated. For example, the correction amounts corresponding to the temperatures can be beforehand set. Then, the correction amount corresponding to the temperature T which is practically detected by the temperature sensor 23 is, for example, added to the pressure variation ΔP having been amplified so that the corrected pressure variation ΔP1 is calculated.

The determination unit 32 performs the determination process for determining whether or not actuate the passenger protection device 40, based on the temperature variation AT detected by the temperature sensor 23 and the corrected pressure variation ΔP1 which is calculated by the correction unit 33. The determination process can be performed similarly to that in the above-described first embodiment with reference to FIG. 4. The pressure threshold Pth and the temperature threshold value Tth which are used in the determination process can be beforehand memorized in the determination unit 32, for example.

In the case where the corrected pressure variation ΔP1 and the temperature variation ΔT are respectively larger than the predetermined threshold values Pth and Tth, it is determined that there occurs the collision at the door 10. Thus, the passenger protection device 40 is actuated.

In this case, because the collision of the door 10 is repeatedly determined according to the pressure variation and the temperature variation of the inner space 13 of the door 10, the determination accuracy can be improved. Furthermore, the pressure variation and the temperature variation in the inner space 13 are in substantial synchronism with each other, so that the collision can be determined at an earlier time. Moreover, because the corrected pressure variation ΔP1 which has been amplified and corrected is used for the determination of the collision, the variability of the pressure variation ΔP detected by the sensor chip 22a due to the ambient temperature T can be restricted.

About the passenger protecting system, what has not been described in the second embodiment is the same with the first embodiment.

### Other Embodiments

Although the present invention has been fully described in connection with the preferred embodiments thereof with reference to the accompanying drawings, it is to be noted that various changes and modifications will become apparent to those skilled in the art.

For example, the space defining member for defining therein the inner space 13 can be also constructed of a vehicle chassis member (e.g., bumper) other than the door 10. In this case, the space defining member having the inner space 13 therein is deformable due to the collision of the vehicle.

Moreover, the heat insulation material can be also provided for one of the inner surface (at inner side of inner space 13) of the outer panel 13 and that of the inner panel 11.

Such changes and modifications are to be understood as being in the scope of the present invention as defined by the appended claims.

What is claimed is:

1. A passenger protecting system for a vehicle, the passenger protecting system comprising:
a space defining member which defines therein an inner space and partially constructs a chassis of the vehicle, the inner space being deformable due to a collision of the vehicle;
a pressure detection member which is arranged in the inner space to detect a pressure of air in the inner space;
a temperature detection member which is arranged in the inner space to detect a temperature of air in the inner space;
a determination unit for determining whether or not there occurs the collision of the vehicle, based on a variation of the pressure detected by the pressure detection member and a variation of the temperature detected by the temperature detection member; and
a passenger protection device for protecting a passenger in the vehicle, the passenger protection device being actuated when the determination unit determines that there occurs the collision of the vehicle.

2. The passenger protecting system according to claim 1, further comprising
a correction unit which determines a corrected pressure by correcting the pressure corresponding to the temperature, the pressure and the temperature being respectively detected by the pressure detection member and the temperature detection member, wherein
the determination unit determines whether or not there occurs the collision of the vehicle based on a variation of the corrected pressure and the variation of the temperature.

3. The passenger protecting system according to claim 1, wherein
a surface of the space defining member for defining the inner space is covered by a heat insulation material.

4. The passenger protecting system according to claim 1, wherein
the pressure detection member and the temperature detection member are arranged in the inner space and positioned in the proximity to each other.

5. The passenger protecting system according to claim 4, further comprising
a housing in which both the pressure detection member and the temperature detection member are arranged, the housing being positioned in the inner space.

6. The passenger protecting system according to claim 1, wherein the space defining member is a door of the vehicle.
